(19) United States
(12) Patent Application Publication
(10) Pub. No.: US 2017/0089552 A1
(43) Pub. Date: Mar. 30, 2017

(54) LAYERED MODULAR LIGHTING CONSTRUCTS AND PROCESSES THEREFOR

(71) Applicant: Serving Form, LLC, Smyrna, GA (US)

(72) Inventor: Kristofer Laméy, Smyrna, GA (US)

(73) Assignee: Serving Form, LLC, Smyrna, GA (US)

(21) Appl. No.: 15/280,771

(22) Filed: Sep. 29, 2016

Related U.S. Application Data
(60) Provisional application No. 62/234,135, filed on Sep. 29, 2015.

(51) Int. Cl. F21V 19/02; A01G 9/20; A01G 7/04; F21V 17/02; F21V 21/088

(52) U.S. Cl. CPC F21V 19/02; F21V 17/02; F21V 21/088; A01G 7/045; A01G 9/20

(57) ABSTRACT

The subject matter of the present disclosure relates, in various embodiments, to modular lighting constructs wherein a plurality of structural members, most often parallel to one another, form spaced-apart layers, and wherein clamping force, applied in some embodiments approximately perpendicularly to a face of each structural member through use of one or more tension assembly comprising a cable, rope, wire, rod, or the like, in association with one or more tubular spacer, is used to draw the structural members into alignment and to provide structural integrity of the modular construct.

### CROSS-REFERENCE TO RELATED APPLICATIONS

The present application claims priority to U.S. provisional patent application No. 62/234,135, filed Sep. 29, 2015, also entitled “Layered Modular Lighting Constructs and Processes Therefor,” the entire contents of which are incorporated herein by reference.

### TECHNICAL FIELD

The subject matter of the present disclosure relates, generally, to modular constructs and to processes for modular construction. More particularly, the subject matter of the present disclosure relates to layered modular lighting constructs, and to processes for creating them, wherein clamping force is applied via cable, rope, wire, rod, or the like, in association with one or more tubular spacer, to draw spaced-apart structural members into alignment and to provide structural integrity of the modular construct.

### BACKGROUND

As a structural design premise, form should always serve function. One explanation of this design premise is that the form of a structure should enhance, and not interfere with, or detract from, the function of the structure in view of its intended purpose and/or use. The same premise should apply, equally, to any smaller component, structure, or element affixed to and/or carried by the structure; as well, to any larger structure to which the structure is affixed and/or which will carry the structure.

While this design premise may be aspirational, it is observably not followed in many structural designs. This is not necessarily the fault of the designer, in that modern design philosophy has tended to be somewhat myopic, focusing on traditional design, manufacturing, fabrication, construction, and assembly techniques.

For example, modern constructs, and associated processes therefor, are most often premised upon box-like structures; to wit, rectangular structures comprising panel-like members exhibiting perpendicular surfaces. Load-carrying members of such structures typically are joined in perpendicular arrangement. That is, structural, load-carrying, panel-like members are most often joined or attached either at the respective ends of two perpendicularly arranged members, as in an “L”-shaped configuration, or at an end of one member and along a flat surface of an adjacent member perpendicular thereto, as in a “T”-shaped configuration.

In a significant number of applications, such box-like structures, and their resulting constructs, may be suboptimal for any of a variety of reasons.

For illustration, one might turn to a particularly exemplary application drawn generally from the lighting fixture arts, as specifically applied in the design and construction of task-based lighting, lighting structures, and other lighting components. In such an application, internal or interior structures, such as lighting fixtures, lighting fixture supports, and other lighting components, must meet a variety of functional requirements. In meeting such functional requirements, a design should be optimized to meet the constraints of the human form, both physical and sensory, experienced during the use and application of the lighting, lighting fixtures, and other lighting components for user tasks, such as study, work on projects, and lighting of objects of use and/or interest. It is observed that conventionally constructed lighting often does not adequately and effectively meet both task-based and human form-based functional requirements.

As might be apparent, internal or interior plant growing lighting fixtures often function to support and hold seeds, sprouts, cuttings, clones, growing trays, growing containers, seed warming mats, and a variety of light dependent organisms and cultures. They provide lighting for counter top and working spaces. They may be configured with sink, water supply, and drainage systems. They are typically wired for illumination and electrical service. They may have computer or other electronic interfaces. In grow lighting of the sort described, they often are finished with powder coated surfaces, colored plastics, or surface labeling.

And yet, while serving the conventional functions described above, grow lighting fixtures must fit and operate within a sometimes tight, carefully allocated space. Not only must they support the above-described contents, as their counterparts must do, they must, further, safely constrain those contents against the stresses arising during daily operations.

For example, they must be fire resistant. They must be resistant to water. They must be capable of withstanding significant dirt, debris, and plant nutrient solutions. And they must be capable of withstanding those elements throughout long service cycles, often measured in tens of years, without degrading or failing. They must, of course, be lightweight so as to improve the user's experience when operating, moving, servicing, or relocating the lighting fixture. For assembly and service, it must have the integrated capability to be assembled and disassembled quickly and easily, with little physical effort, and with few or no tools needed. This represents, of course, a small sampling of the many functional considerations with regard to the lighting fixture's performance.

Notwithstanding the environments, requirements, and constraints to which such lighting fixture internal or interior structures are subjected, they continue—disadvantageously—to be designed, manufactured, and assembled as fixed box-like structures. The following discussion seeks to convey an understanding of why such a fixed box-like structure is disadvantageous with regard to the exemplary grow lighting fixture or interior structures under consideration.

In order to meet the functional challenges to which they are subjected, while remaining utilitarian for the reasons described above, grow lighting fixtures and lighting fixture supports most typically are constructed using steel and plastic materials. While these materials are sufficient, they are relatively unsuitable for a functional performance lasting more than a few years. Additionally, their principal weakness is due to the integrity, strength, and quality of the material used to construct conventional lighting fixtures. Also, the methods used to join said materials into indented forms are generally not sturdy, require the need of tools, and are fixed in a fashion that prohibits an easy, substantially tool-less assembly and disassembly. Furthermore, said conventional lighting fixtures are not intended to be disassembled and reassembled into multiple or different configurations, sometimes with the addition of optional parts or such multiple or different configurations as may be provided by or within the base system itself.

Rather, and long ago, the lighting fixture industry adopted the use of nuts, bolts, adhesives, welding, and the like, to join structural members. With such construction, these fasteners and methods of joining—especially forms of joining such as welding or adhering—by nature cultivate the lack of modularity in conventional lighting fixtures. Within the realm of indoor growing applications, such as in hydroponics, the variability of scope, requirement, and subject matter that may arise within an end user's various projects may contribute to the need for the end user to perpetually modify his or her work space. On the other hand, conventional grow lighting fixtures are most often bulky and fixed in a manner that prohibits the modularity of the fixture.

As a result of the conventional grow light fixture's inability to adapt to the ever growing changes and demands in a user's work space, the end user is left with inadequate options to optimize his or her work and space efficiency. Due to these limitations and, especially, the lack of modularity within conventional lighting fixtures and methods, an end user must, at times, find and provide more space for additional lighting fixtures. This is often because conventional grow light fixtures are unable to accept a larger working capacity. For example, conventional grow light fixtures do not provide for modular construction within the design's platform and, therefore, lack the ability to expand from a single lamp and/or bulb to a configuration supporting multiple lamps and/or bulbs, each with sufficient adjustably to position the light source to allow the illumination of a larger surface area.

Notwithstanding the above, even when considering human interface factors and ergonomics, box-like modular constructs of the type described are demonstrably suboptimal. This is especially true when considering an always-changing and diverse end user space and associated end user-specific requirements. Consider, for example, the diversity of space and use requirements amongst users such as a botanist, a seamstress, an attorney, and an artist. A box-like structure is intrusive, in that such structures are inherently bulky and space-monopolizing. Because available space typically is already scarce, human interfaces become even more cumbersome: consider the space necessary for rotating and pruning plant cuttings; consider how a user opening a drawer or cabinet must position his or her body within the limited, available space to accommodate that function.

In fact, with a box-like construct, the user must adapt to the space and modular configuration provided, rather than the space and modular construct preferably supporting the user's functional and ergonomic needs. If considered honestly, one would conclude that this is not how a user should be required to interact with a workspace—or any other space for that matter. That is to say, in such suboptimal, conventional, prior art lighting structures, function must adapt to meet the provided form, rather than the provided form being adapted to meet the necessary or desirable function, as was posited at the outset to be the aspirational design premise.

Accordingly, in considering the “form should always serve function” design aspiration set forth at the outset of this discussion, a desirable solution to the above-described deficiencies in the prior art modular constructs and related processes would allow one, in appropriate cases, to avoid the construction of boxlike structures. Rather, such a solution would allow a designer to specify a modular construct that better enables a user to gain access to and operate within particularized functional parameters, without hindrance by bulky and space-monopolizing structures.

A desirable solution would reduce design and production complexity. It would reduce the need for skilled assemblers. It would allow for repeatability between similar modular structures. If in-process error or damage should occur, the modular structure could be easily and inexpensively repaired. Post-delivery or post-hoc reconfiguration and modification could more easily be handled, and with significantly less expense and downtime. Importantly, a desirable solution would allow convenient and relatively inexpensive transportation of unassembled components of a modular construct to a desired location, whereafter the modular structure could be efficiently assembled in-situ or on-site; thereby, minimizing or avoiding extended out-of-service situations.

A desirable solution would, of course, take advantage of the many benefits accompanying advanced manufacturing technologies, such as precision computer numerically controlled water jet cutting, plasma cutting, laser cutting, and the like, while avoiding the need for skilled, by-hand lay-up and assembly processes.

A desirable solution would enhance, not detract from, human interface design and ergonomics. Rather, modular constructs built according to such a desirable solution would better flow into available spaces, reducing footprint and required operating space, while maintaining—or increasing—operational performance and user comfort.

And a desirable solution would be useful and functional when applied to any of a variety of applications.

Thus, the “form should always serve function” design premise—and a desirable solution implementing it—would provide a paradigm shift in design, manufacturing, fabrication, construction, assembly, and/or like processes; in turn, leading to reductions in human labor, reductions in need for the wide variety of fasteners and corresponding assembly tools, reductions in assembly, manufacturing, and related costs, increases in efficiency, increases in design-to-finished-structure speed and predictability, more efficient and improved scalability, more efficient re-purposing and reconfiguring of the structure, decreased weight, and like benefits. In appropriate cases, such paradigm shift in design, manufacture, fabrication, construction, and/or assembly might provide stronger constructs, reductions in failure rates, tunable rigidity, and flexibility within the modular construct, and like benefits, due to improvements in the way load carrying parts are used, combined, aligned, attached, and integrated into and within the structure.

Accordingly, it is to the disclosure of such modular constructs, processes for modular construction, and related lighting systems that the following is directed.

### SUMMARY

The subject matter of the present disclosure relates, in various embodiments, to modular lighting constructs wherein a plurality of structural members, most often parallel to one another, form spaced-apart layers, and wherein clamping force, applied in some embodiments approximately perpendicularly to a face of each structural member through use of one or more tension assembly comprising a cable, rope, wire, rod, or the like, in association with one or more tubular spacer, is used to draw the structural members into alignment and to provide structural integrity of the modular construct.

According to some embodiments, a plurality of guiding offset rests aid similarly constructed, modular substructures in nesting into a primary modular structure, wherein each modular substructure comprises a plurality of structural members most often parallel to one another, forming spaced-apart layers, interconnected via one or more tension assembly.

Appropriate structural mounts may be provided in order to removably affix modular structures according to the present disclosure to a table, wall, or other support, work surface, or structural interface.

Uniquely, all assemblies, subassemblies, and components are designed and configured to be easily assembled, tightened, loosened, and disassembled, both by module and by individual component, through a distinctive, single side access system, which, in most embodiments, requires use of only a single, modest tool. Modular structures according to the present disclosure advantageously may be entirely constructed, maintained, and/or reconfigured from a single side due to the layered structure and design of such modular structures, in association with tension assembly-based, layer-interconnection means. Upon completion of assembly, the tension assembly conveniently may be tightened from a single side of the modular structure, preferably making use of a single tool, such as a screwdriver.

Further, and importantly, should any maintenance and/or reconfiguration of a modular structure according to the present disclosure be required, one need simply loosen relevant tension assemblies from a single side of the modular structure, and subsequently remove only those component parts necessary to access the layer or feature of interest. One may then repair, maintain, replace, reconfigure, and/or the like, those component parts of interest; thereafter, replacing subsequent component parts in defined order in association with relevant tension assemblies. Upon completion of reassembly, relevant tension assemblies may be retightened from a single side of the modular structure.

The subject matter of the present disclosure may find particular application within modular constructs, such as, but not limited to, those for class rooms, libraries, laboratories, botanical growing areas, assembly lines, offices, kitchens, and the like.

These, and other, features, advantages, and benefits shown by the various embodiments of the layered modular lighting constructs and related processes for creating them, as set forth within the present disclosure, will become more apparent to those of ordinary skill in the art after review of the following Detailed Description of Illustrative Embodiments and Claims in light of the accompanying drawing Figures.

### BRIEF DESCRIPTION OF THE DRAWINGS

Accordingly, the within disclosure will be best understood through consideration of, and with reference to, the following drawing Figures, viewed in conjunction with the Detailed Description of Illustrative Embodiments referring thereto, in which like reference numbers throughout the various Figures designate like structure, and in which:

FIG. 1 depicts a side elevation view of an embodiment of modular lighting structure, in accordance with the subject matter of the present disclosure;

FIG. 2 depicts a first rear elevation view of the modular lighting structure of FIG. 1, in accordance with the subject matter of the present disclosure;

FIG. 3 depicts a rear perspective elevation view of the modular lighting structure of FIG. 1, in accordance with the subject matter of the present disclosure;

FIG. 4A depicts a side elevation view of an alternative embodiment of the modular lighting structure of FIG. 1, configured to support two lamps in a forward and rearward orientation, in accordance with the subject matter of the present disclosure;

FIG. 4B depicts a rear elevation view of the modular lighting structure of FIG. 4A configured to support two lamps in a forward and rearward orientation, also depicting an optional seed tray mounted to a top of a base, in accordance with the subject matter of the present disclosure;

FIG. 4C depicts a front perspective view of the modular lighting structure of FIG. 4A configured to support two lamps in a forward and rearward orientation, also depicting an optional seed tray mounted to a top of a base, in accordance with the subject matter of the present disclosure;

FIG. 5A depicts a front perspective view of an alternative embodiment of the modular lighting structure of FIG. 1, supporting three lamps in a “side-by-side” configuration in a forward orientation, also depicting an optional seed tray mounted to a top of a base, in accordance with the subject matter of the present disclosure;

FIG. 5B depicts a perspective view of an alternative embodiment of the modular lighting structure of FIG. 5A supporting three lamps in a “side-by-side” configuration in a forward orientation and a one lamp in a rearward orientation, also depicting an optional seed tray mounted to a top of a base, in accordance with the subject matter of the present disclosure;

FIG. 5C depicts a top view of the modular lighting structure of FIG. 5B supporting three lamps in a “side-by-side” configuration in a forward orientation and a one lamp in a rearward orientation, also depicting an optional seed tray mounted to a top of a base, in accordance with the subject matter of the present disclosure;

FIG. 5D depicts a rear perspective view of the modular lighting structure of FIG. 5A supporting three lamps in a “side-by-side” configuration in a forward orientation, the lamps shown adjusted in a lower position along the vertical support, also depicting an optional seed tray mounted to a top of a base, in accordance with the subject matter of the present disclosure;

FIG. 6 depicts a top view of a representative modular lighting structure of the present disclosure in parts, in accordance with the subject matter of the present disclosure;

FIG. 6A depicts a top isometric view of a representative modular lighting structure of FIG. 6 in parts, in accordance with the subject matter of the present disclosure;

FIG. 6B depicts a side isometric view of the modular lighting structure of FIG. 6A in parts, and depicting a vertical support thereof bent into shape, in accordance with the subject matter of the present disclosure;

FIG. 6C depicts a side isometric view of the modular lighting structure of FIG. 6B in parts, and depicting a vertical support thereof bent into shape and slid into corresponding notches on a base, in accordance with the subject matter of the present disclosure;

FIG. 6D depicts a side isometric view of the modular lighting structure of FIG. 6C in parts, and depicting a vertical support thereof bent into shape and slid into corresponding notches on a base, and further depicting a saddle assembly plate bent, in accordance with the subject matter of the present disclosure;

FIG. 6E depicts a side isometric view of the modular lighting structure of FIG. 6D in parts, and depicting a vertical support thereof bent into shape and slid into corresponding notches on a base, and further depicting a saddle assembly plate bent and slid onto a T5 lighting lamp, in accordance with the subject matter of the present disclosure;

FIG. 6F depicts a side isometric view of the modular lighting structure of FIG. 6E in parts, and depicting a vertical support thereof bent into shape and slid into corresponding notches on a base, and further depicting a saddle assembly plate bent and slid onto a T5 lighting lamp, and further depicting one of the plurality of tensioning assemblies next to the saddle plate, in accordance with the subject matter of the present disclosure;

FIG. 6G depicts a side isometric view of the modular lighting structure of FIG. 6F in parts, depicting a vertical support thereof bent into shape and slid into corresponding notches on a base, further depicting a saddle assembly plate bent and slid onto a T5 lighting lamp, further depicting a tension assembly within the bent saddle plate, in accordance with the subject matter of the present disclosure;

FIG. 6H depicts a side isometric view of the modular lighting structure of FIG. 6G in parts, and depicting a T5 lamp and saddle plate with one tension assembly positioned in front of a vertical support thereof, in accordance with the subject matter of the present disclosure;

FIG. 6i depicts a side isometric view of the modular lighting structure of FIG. 6H in parts, and depicting a T5 lamp and saddle plate with one tension assembly pushed into a vertical support, wherein another tension assembly is to be placed at a rear of the bent saddle plate, in accordance with the subject matter of the present disclosure;

FIG. 6J depicts a side isometric view of the modular lighting structure of FIG. 6i, and depicting a T5 lamp and saddle plate with one tension assembly pushed into a vertical support thereof, and further depicting another tension assembly placed at the rear of the bent saddle plate, wherein in this configuration, the T5 lamp is retained and supported along the vertical support, in accordance with the subject matter of the present disclosure;

FIG. 6K depicts a side isometric view of the modular lighting structure of FIG. 6J, and further depicting a saddle assembly tilted to release the leveraged tension from terminating ends of the tension assemblies, wherein, once this tension is released and the saddle assembly is tilted, the T5 lamp can easily be moved upwardly or downwardly along a vertical support thereof to any of a plurality of positions along the vertical support, in accordance with the subject matter of the present disclosure;

FIG. 6L depicts a side isometric view of the modular lighting structure of FIG. 6K, and further depicting a saddle assembly tilted to release the leveraged tension from terminating ends of the tension assemblies, the saddle assembly tilted and moved upwardly along a vertical support thereof, in accordance with the subject matter of the present disclosure;

FIG. 6M depicts a side isometric of the modular lighting structure of FIG. 6L, and further depicting a saddle assembly released from the tilted position, wherein tension has been placed onto terminating ends of the tension assemblies to fix the saddle assembly onto a higher portion of a vertical assembly thereof, and further depicting a T5 lamp supported at a higher position than shown in FIG. 6J, in accordance with the subject matter of the present disclosure;

FIG. 7 depicts a top view of a saddle assembly parts matrix before the parts are separated from the tabs retaining the parts in the cut out negative, the procedure preferably easily done by hand of the end user, in accordance with the subject matter of the present disclosure;

FIG. 7A depicts a top isometric view of a saddle assembly parts matrix of FIG. 7 before the parts are separated from the tabs retaining the parts in the cut out negative, the procedure preferably easily done by hand of the end user, in accordance with the subject matter of the present disclosure;

FIG. 7B depicts a top isometric view of a saddle assembly parts of FIG. 7A after the parts are separated from the tabs, in accordance with the subject matter of the present disclosure;

FIG. 7C depicts a top isometric view of a saddle assembly of FIG. 7B being assembled in stages, from leftmost to rightmost, in order to retain a T5 lamp using saddle assembly embodiment, in accordance with the subject matter of the present disclosure;

FIG. 7D depicts a top view of a base assembly shown with vertical support cross members, wherein, within the base assembly, the needed cross members for the vertical support assembly are fabricated within the base to be separated from tabs and assembled by hand of the end user, in accordance with the subject matter of the present disclosure;

FIG. 7E depicts a top isometric view of a base assembly of FIG. 7D shown without the vertical support cross members within the base, in accordance with the subject matter of the present disclosure;

FIG. 7F depicts an exploded, isometric view of a vertical support assembly of FIG. 7D with tension assemblies shown fastening ends of the vertical support, in accordance with the subject matter of the present disclosure;

FIG. 8 depicts an isometric view of an alternative embodiment of the modular lighting structure of the present disclosure with a layered, modular clamping mechanism in lieu of a base assembly, in accordance with the subject matter of the present disclosure;

FIG. 8A depicts a side isometric view of the modular lighting structure of FIG. 8 clamped to a work surface, in accordance with the subject matter of the present disclosure; and

FIG. 8B depicts a rear isometric view of the modular lighting structure of FIG. 8 clamped to a work surface, in accordance with the subject matter of the present disclosure.

It is to be noted that the drawing Figures presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF ILLUSTRATIVE EMBODIMENTS

In describing the several embodiments illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose. Additionally, in the Figures, like reference numerals and like description shall be used to designate corresponding elements, parts, and functionality throughout the several Figures.

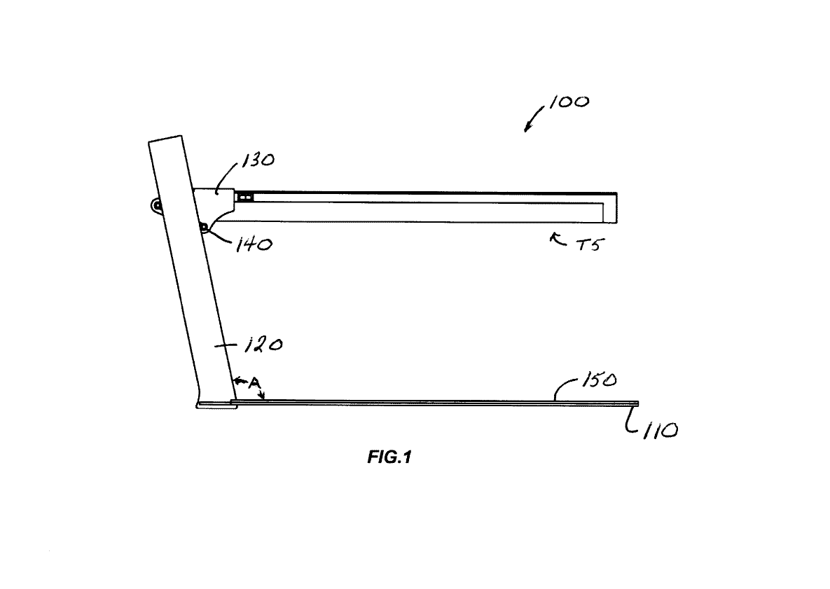

Turning now to the drawing Figures, generally, and specifically to FIG. 1, a side elevation view of an embodiment of modular lighting structure 100 is depicted. Modular lighting structure 100 includes base 110, vertical support 120, saddle assembly 130, tension assemblies 140, and optional seed tray 150. Modular lighting structure is configured so as to accept, hold, and position elongated lamp or bulb assembly T5 of conventional design and manufacture.

In an exemplary configuration, elongated lamp or bulb assembly preferably is a T5 strip light high output fluorescent fixture. As shown in the Figures, elongated lamp or bulb assembly T5 is typically 24 inches in length, and provides approximately 2,000 lumen at 24 watts. In such form, elongated lamp or bulb assembly T5 includes its lamp or bulb, a preferably aluminum housing, an appropriate lamp or bulb shroud, an appropriately sized and configured ballast, and appropriate electrical wiring, conductors, and the like.

It is noted that, although the depicted embodiments show elongated lamp or bulb assembly T5 in length proportional to base 110, any of a variety of lengths of elongated lamp or bulb assembly T5 may be used and interchanged without modification of modular lighting structure 100. This is true because any commonly available length of elongated lamp or bulb assembly T5 will fit into a common saddle assembly 130. So long as there is sufficient counterweight, clamping force, or base weight available to prevent unwanted tipping of modular lighting structure 100, the length of elongated lamp or bulb assembly T5 is immaterial to the function, benefits, and advantages provided by modular lighting structure 100, and in many circumstances, may provide a significant further benefit not provided within prior art devices.

It may be observed in FIG. 1 that vertical support 120 is disposed at angle A; rearward with respect to base 110. Angle A advantageously provides additional room for a seed tray, container, or other lighted object to be disposed under elongated lamp or bulb assembly T5, without interference from vertical support 120. This is especially true given that many trays, containers, and the like, are provided with an outwardly disposed draft or taper angle. With this configuration, a seed tray, container, or other lighted object disposed under elongated lamp or bulb assembly T5 may have the full benefit of the light provided thereby.

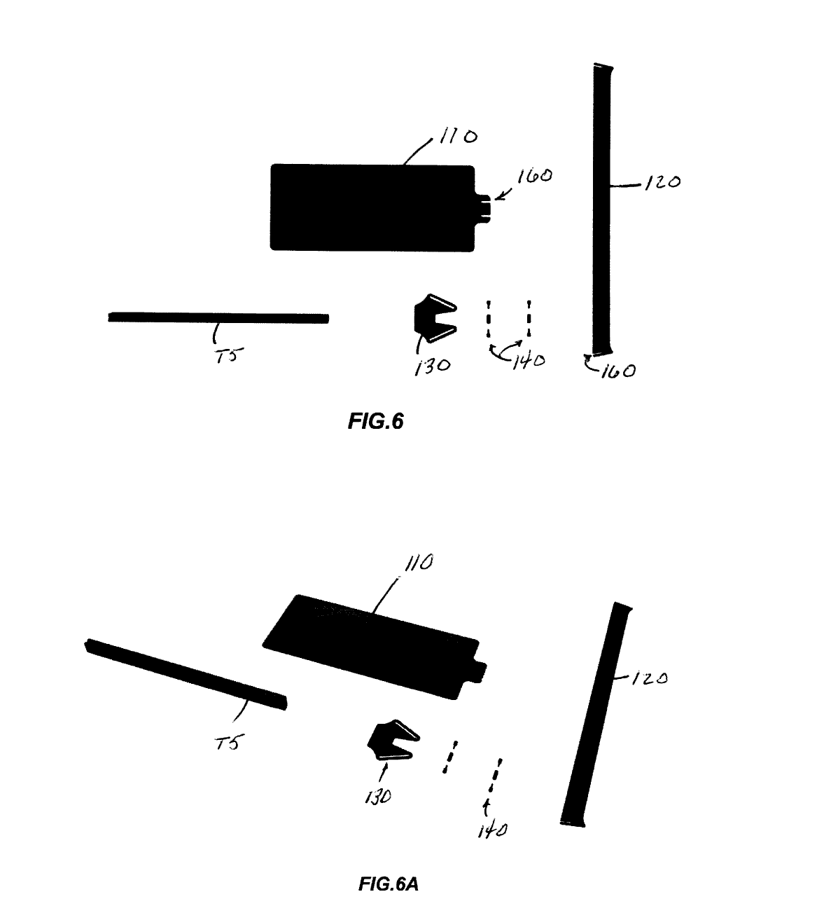

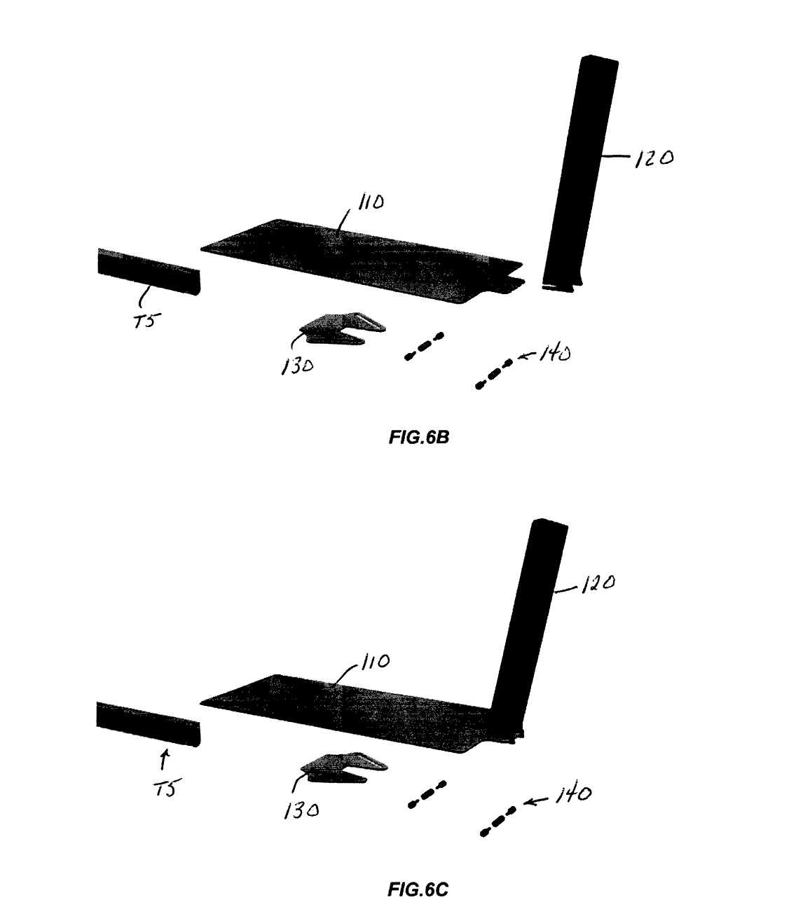

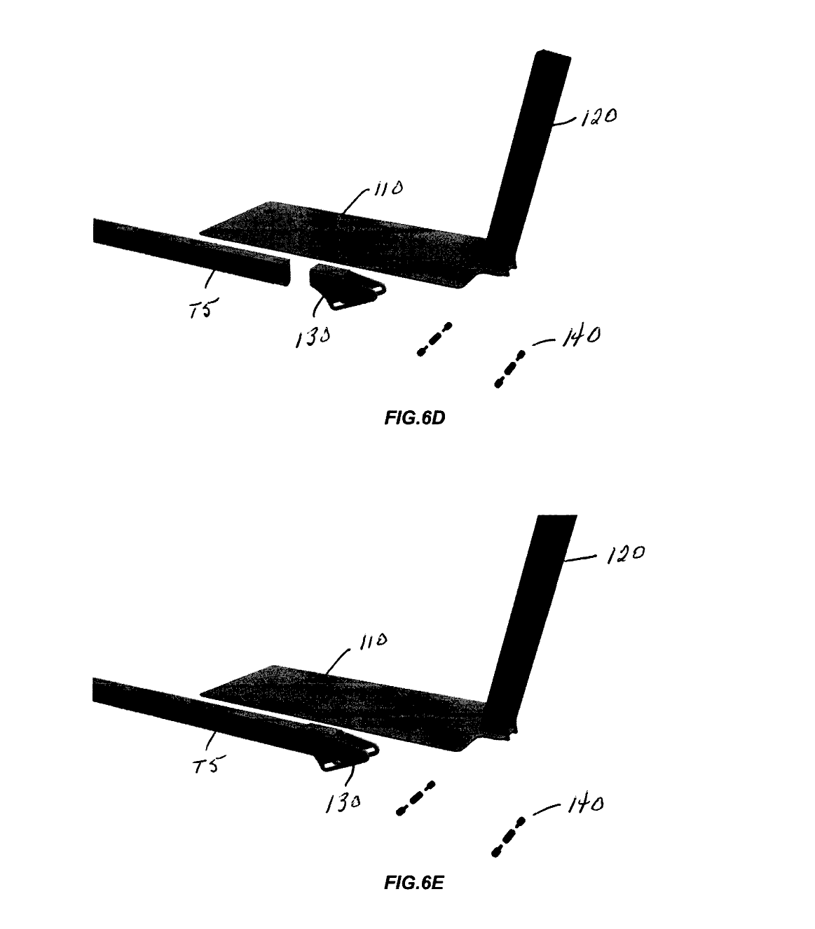

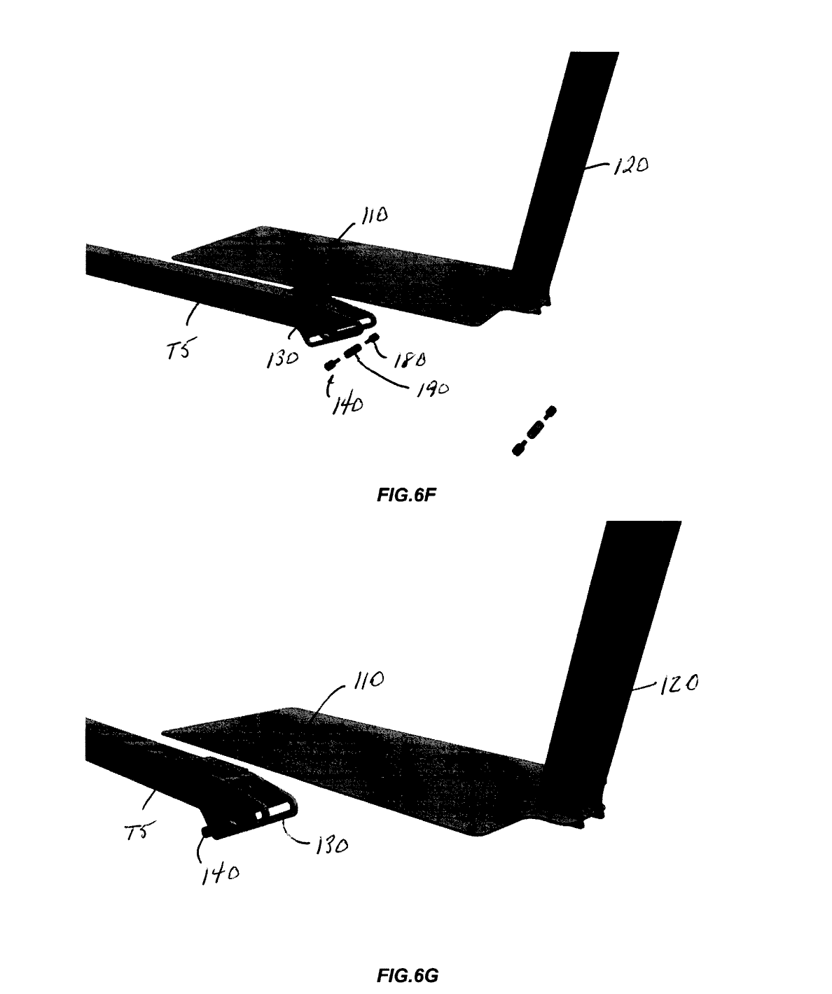

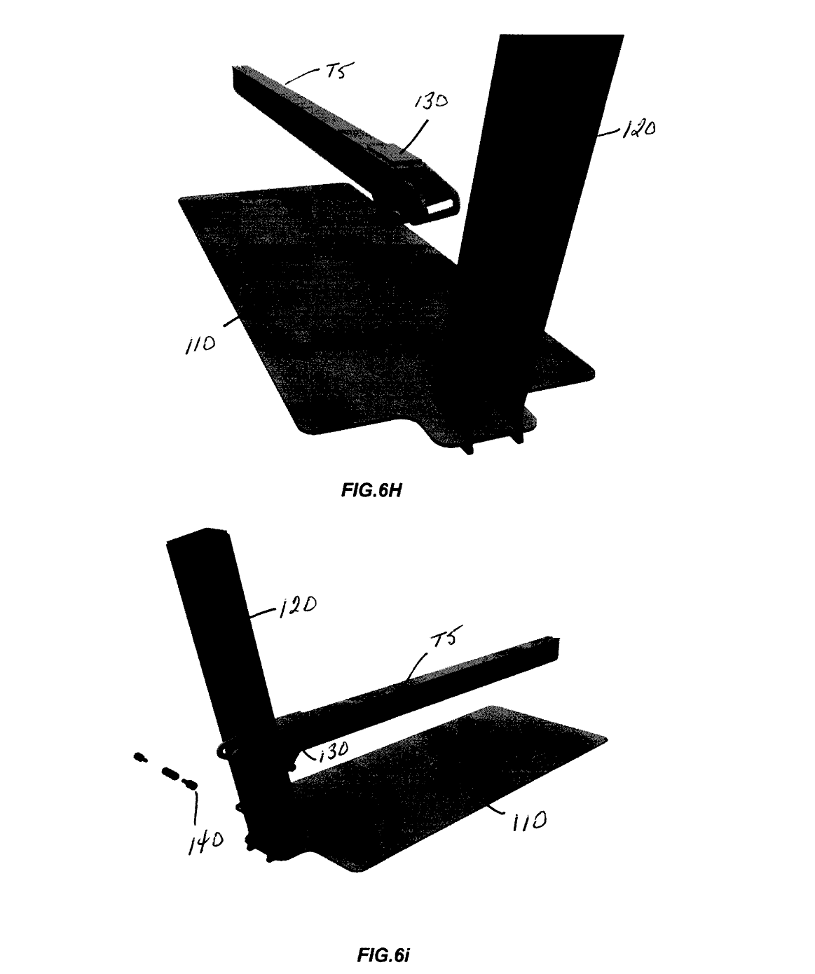

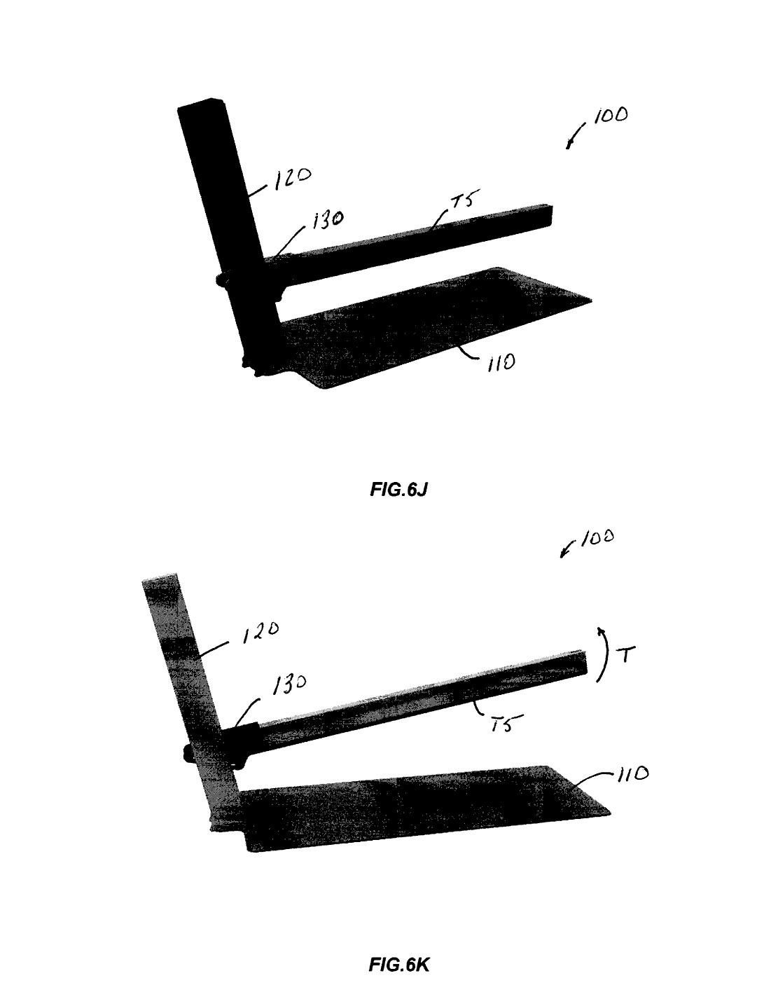

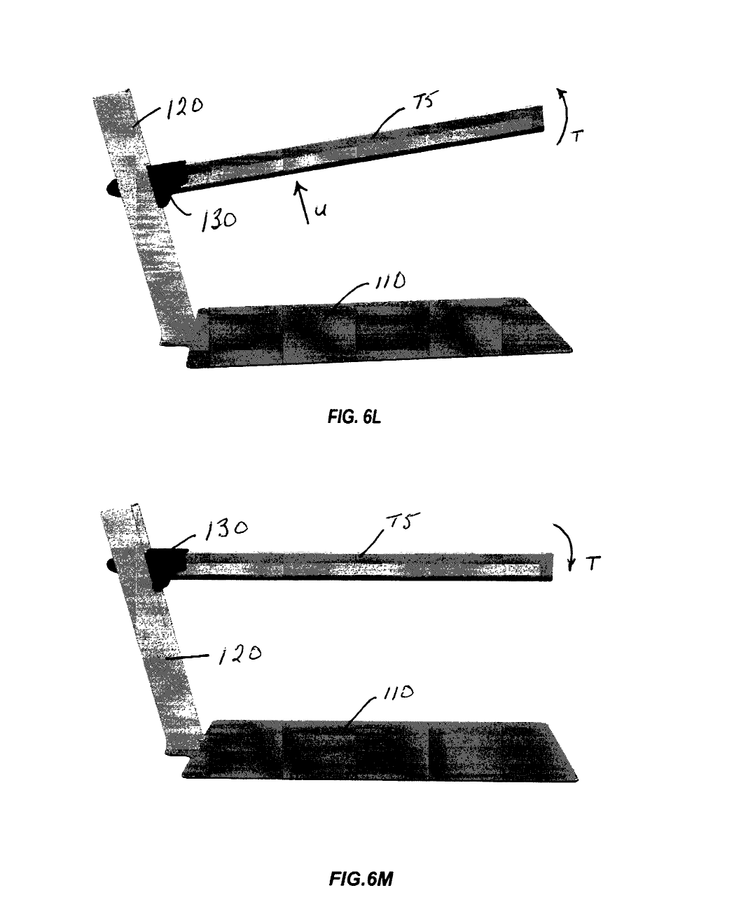

Perhaps more importantly, however, angle A provides an important functional aspect, one which will be discussed in greater detail hereinbelow during consideration of FIGS. 6J-6M. It will be seen that angle A provides for upward tilting of saddle assembly 130 and its corresponding elongated lamp or bulb assembly T5, removing the associated bearing forces from tension assemblies 140, and allowing saddle assembly 130 and its elongated lamp or bulb assembly T5 to be moved upwardly or downwardly along vertical support 120 and into any of a variety of user-selected positions. When saddle assembly 130 and its elongated lamp or bulb assembly T5 is in an appropriate position, saddle assembly 130 and its elongated lamp or bulb assembly T5 is tilt-lowered back into its resting, re-tensioned position, wherein it is maintained in a cantilevered-type support arrangement and configuration by normal bearing forces until moved again by the user.

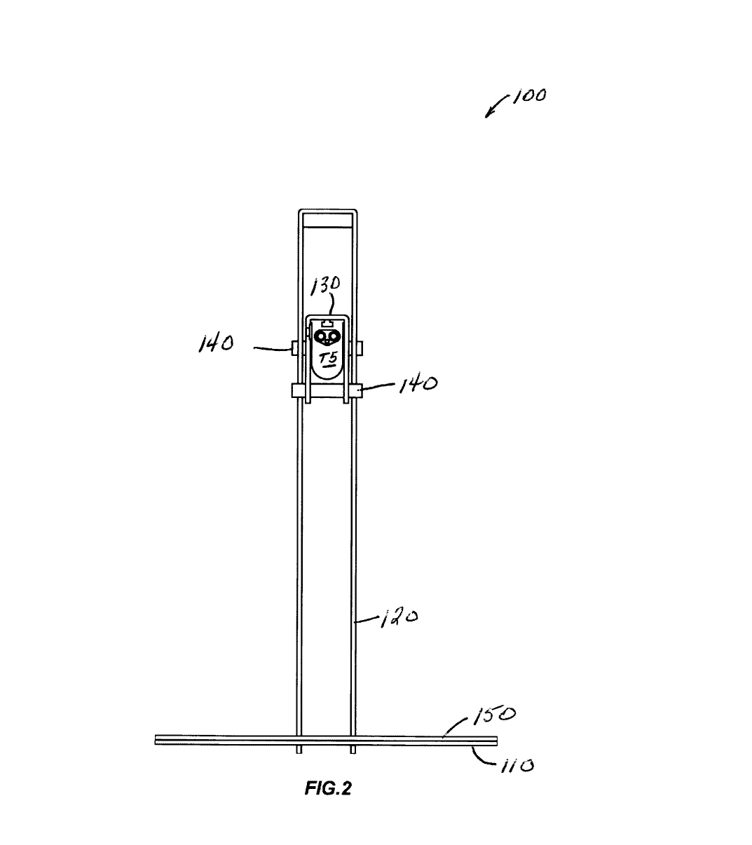

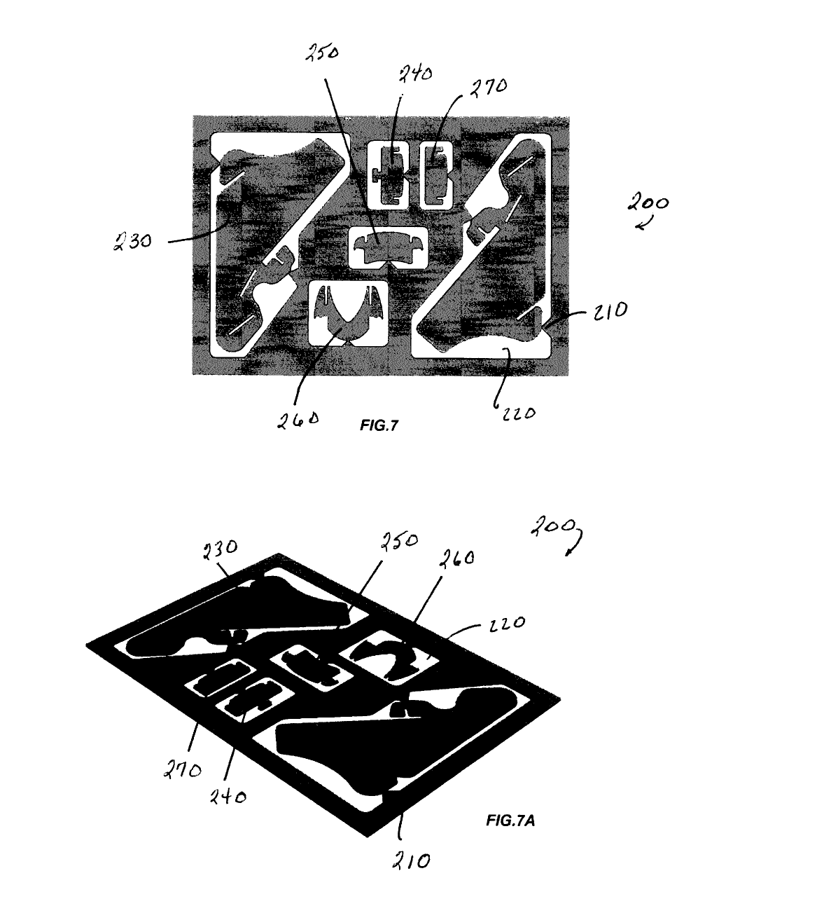

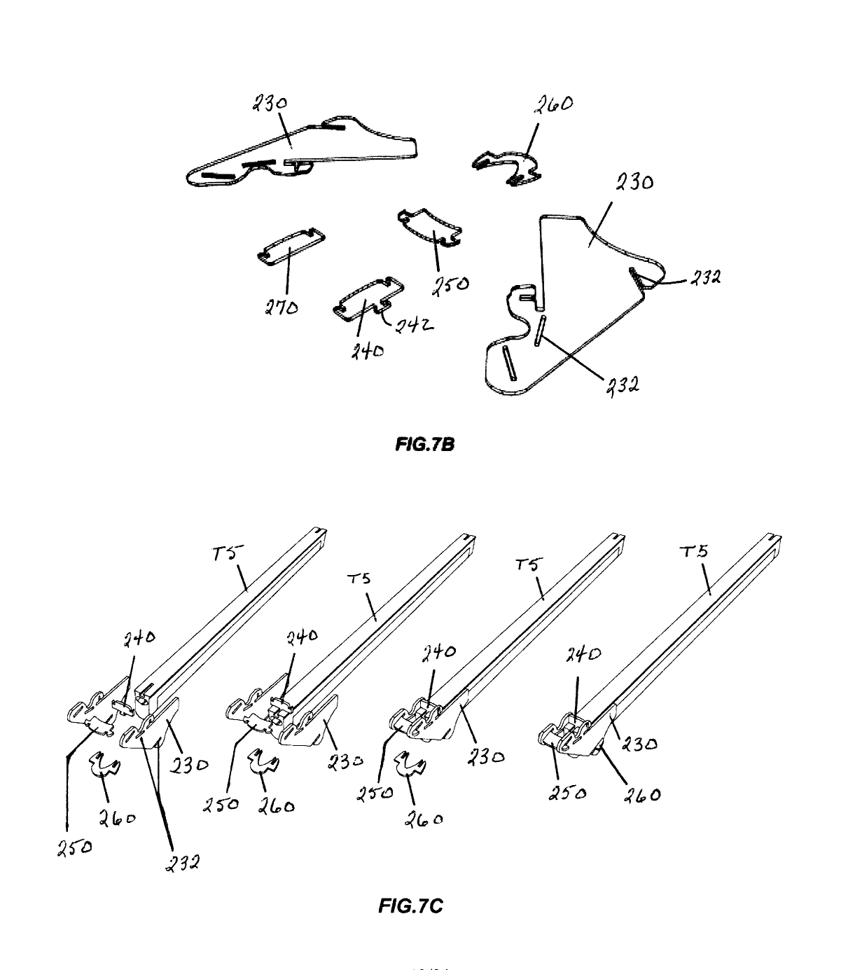

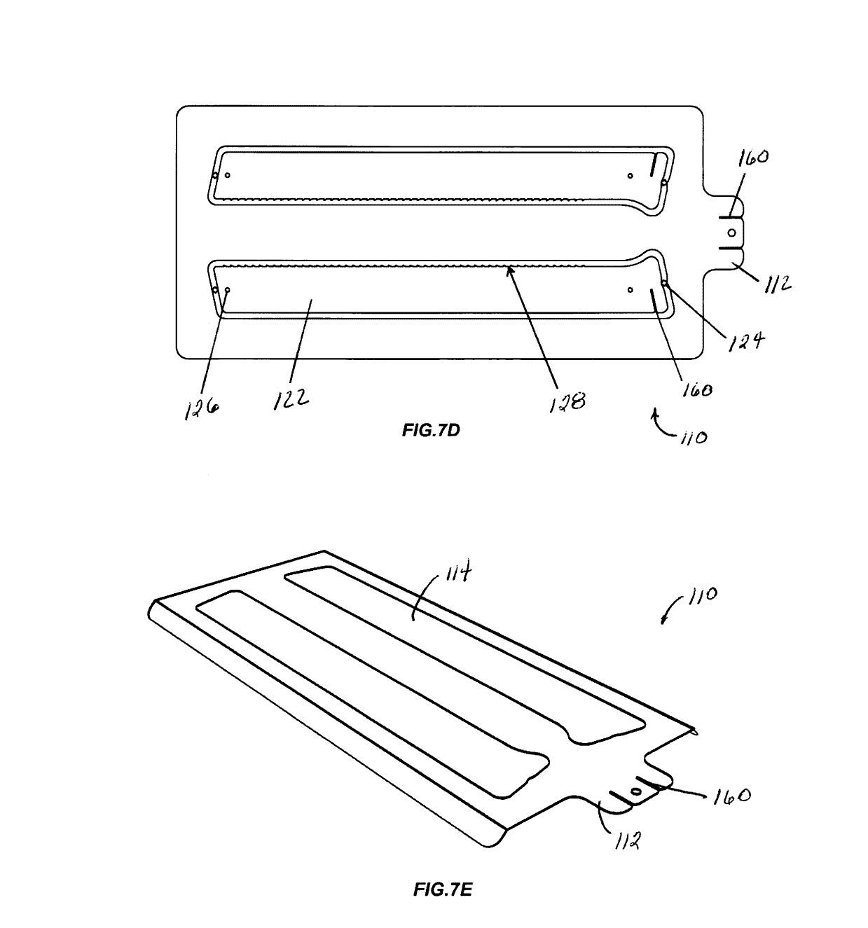

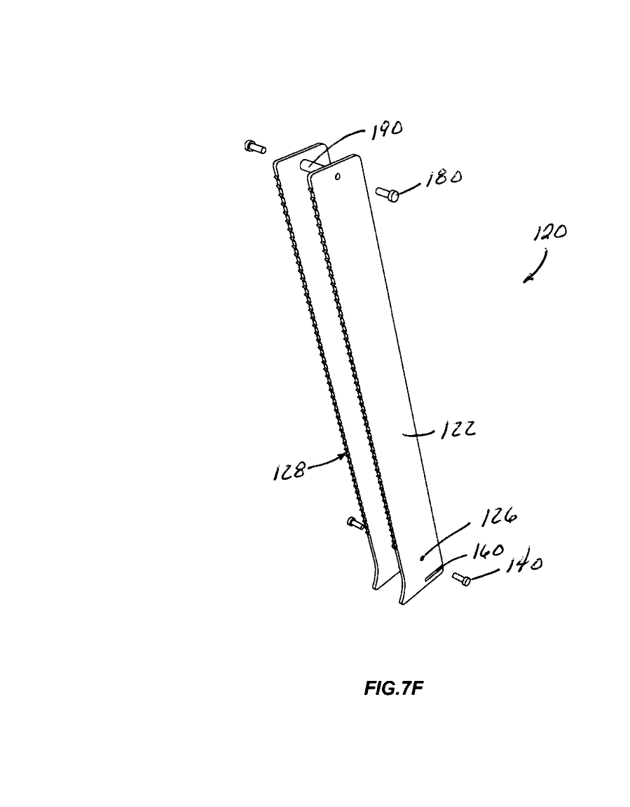

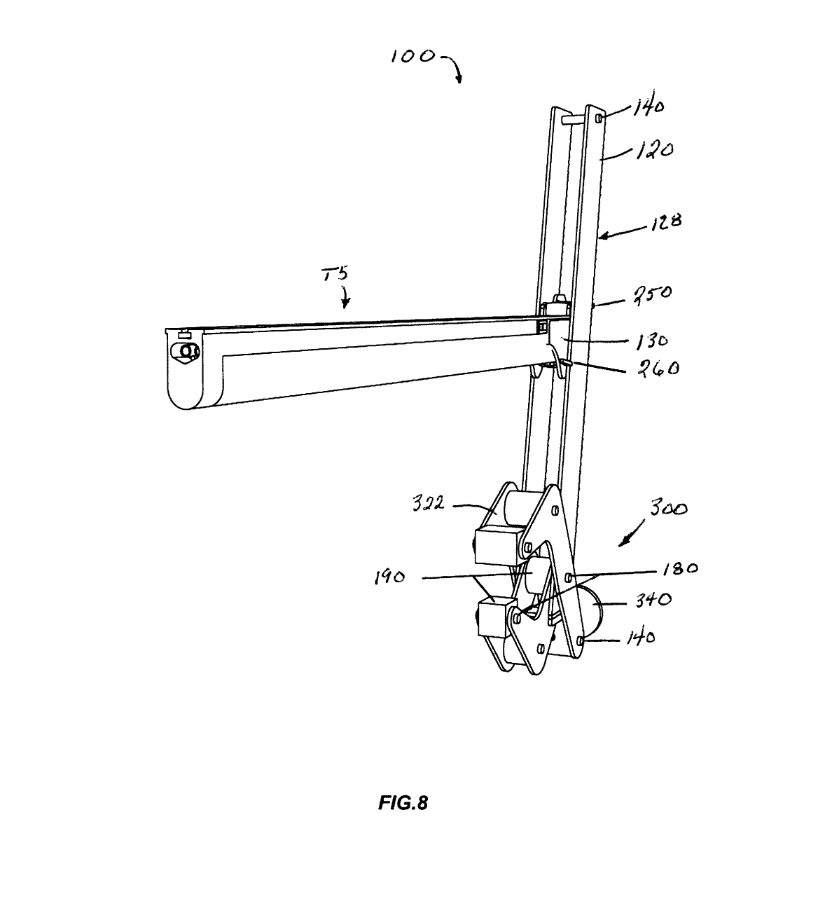

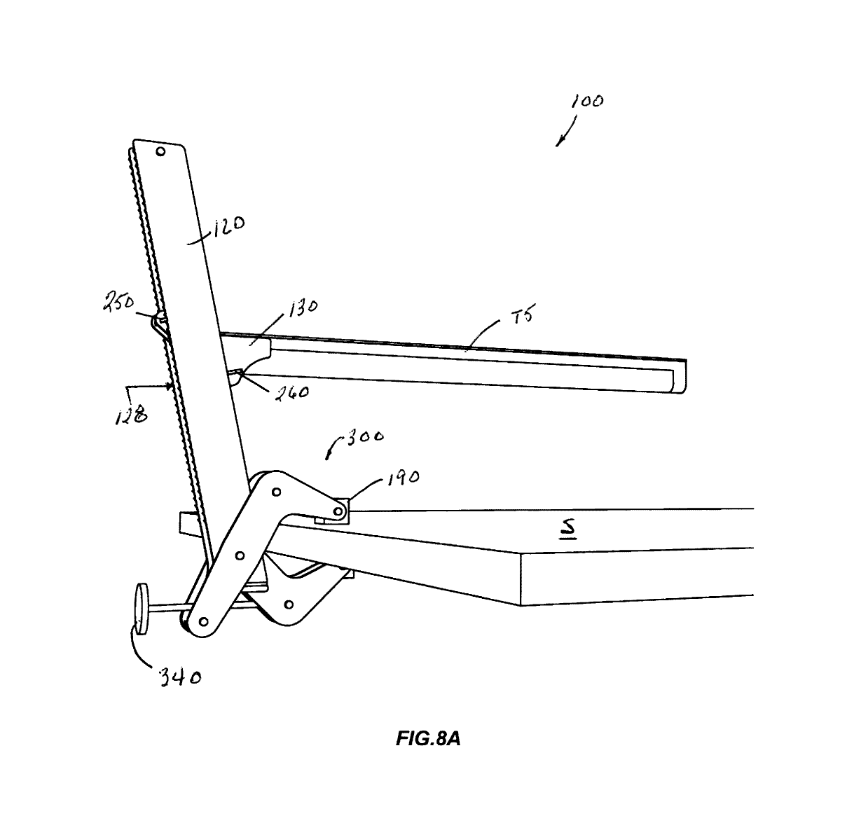

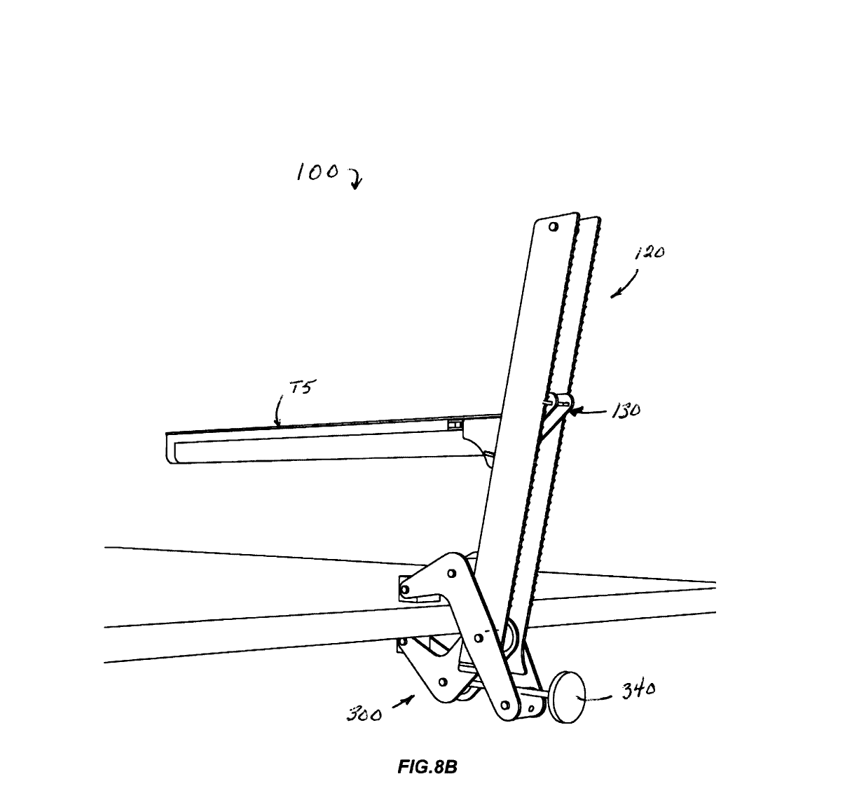

FIG. 2 depicts a first rear elevation view of modular lighting structure 100 of FIG. 1. As may best be seen in this Figure, elongated lamp or bulb assembly T5 most typically has at least one T-shaped slot enabling its mounting in association with any of a variety of conventional holders. It is noted that this slot may advantageously be utilized as depicted hereinbelow with respect to FIGS. 7-8B.

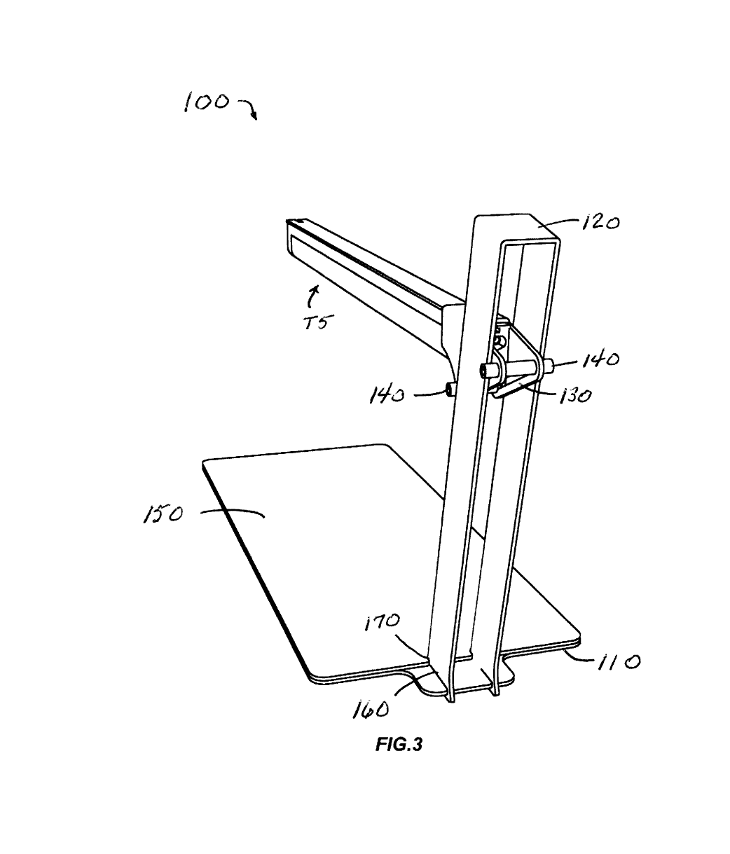

FIG. 3 depicts a rear perspective elevation view of modular lighting structure 100 of FIG. 1. As may best be seen in this Figure, vertical support 120 may have one or more slot 160 configured to receive suitably and cooperatively configured base 110. Vertical support 120 may further have one or more notch 170 configured to receive suitably and cooperatively configured optional seed plate 150. Notch 170 may take any of a variety of forms, including slotted, indented, notched, and like forms.

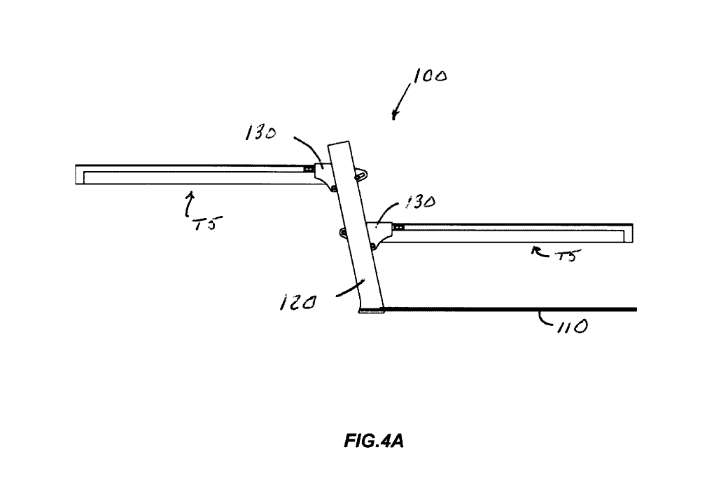

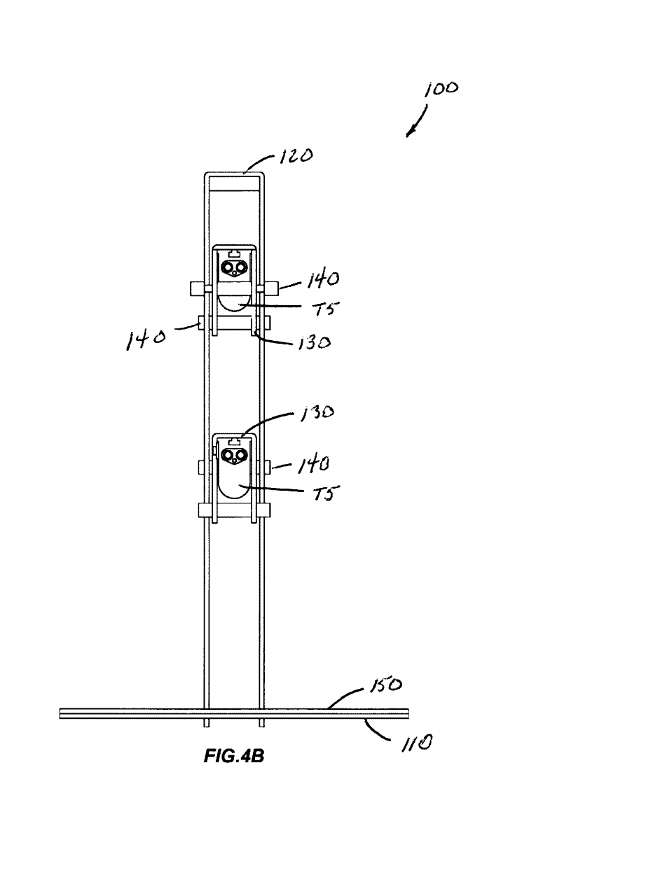

Turning next to FIG. 4A, depicted is a side elevation view of an alternative embodiment of modular lighting structure 100 of FIG. 1, configured to support two elongated lamp or bulb assemblies T5, one each in a forward and rearward orientation. In such embodiment, second saddle assembly 130 is received by vertical support 120, but is oriented in a rearward facing direction. In such configuration, second elongated lamp or bulb assembly T5 may be received and mounted thereto. Although FIG. 4A depicts rearward facing elongated lamp or bulb assembly T5 at an elevation higher than forward facing elongated lamp or bulb assembly T5, it will be readily apparent that the relative elevation positions may be reversed, so that forward facing elongated lamp or bulb assembly T5 is at an elevation higher than rearward facing elongated lamp or bulb assembly T5.

FIG. 4B depicts a rear elevation view of modular lighting structure 100 of FIG. 4A configured to support two elongated lamp or bulb assembly T5, one each in a forward and rearward orientation. FIG. 4B further depicts an optional seed tray 150 resting atop base 110, as previously described.

FIG. 4C depicts a front perspective view of modular lighting structure 100 of FIG. 4A configured to support two elongated lamp or bulb assembly T5, one each in a forward and rearward orientation. FIG. 4C further depicts an alternative form of optional seed tray 150 resting atop base 110, as previously described.

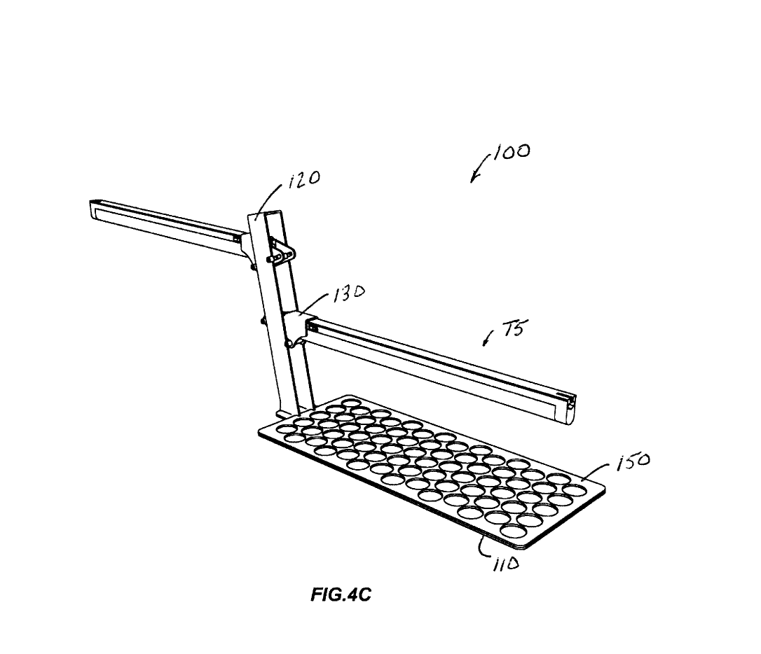

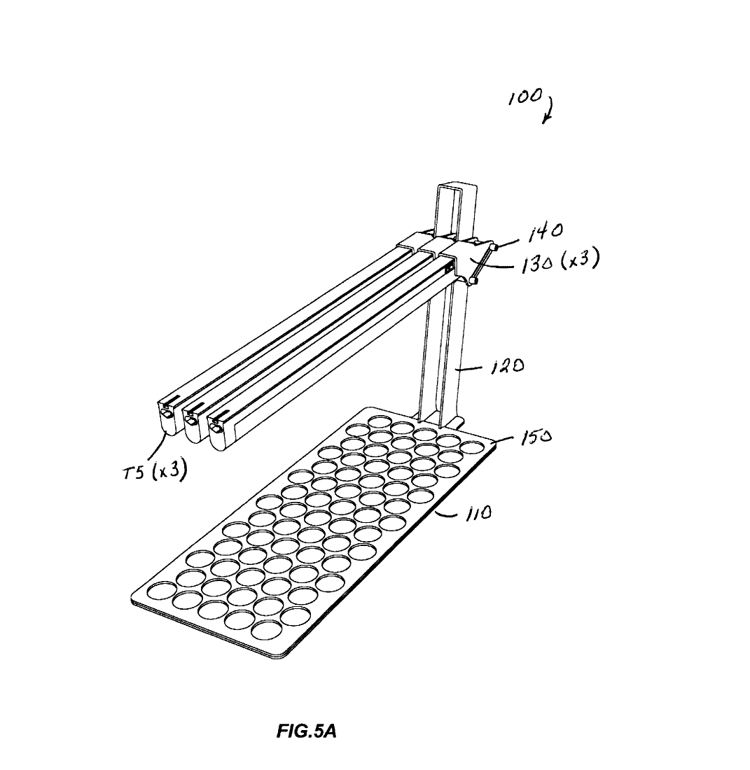

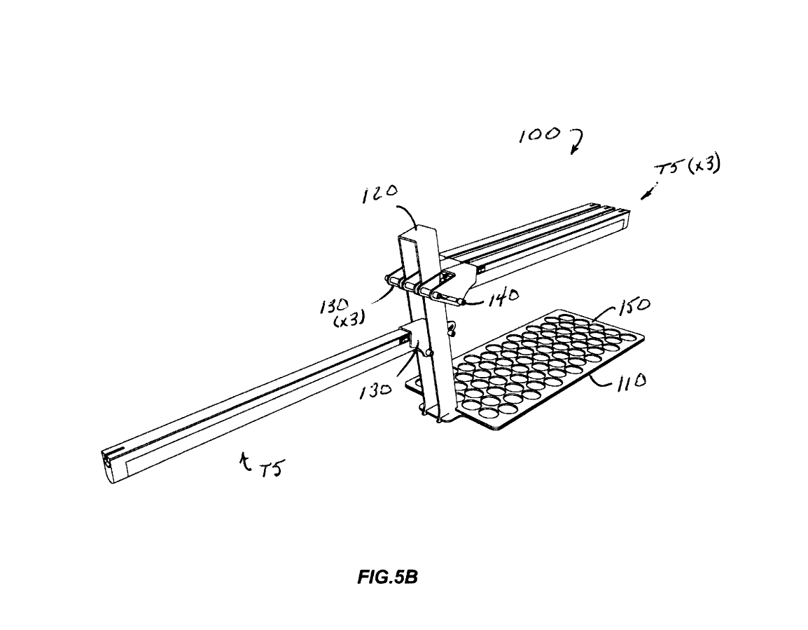

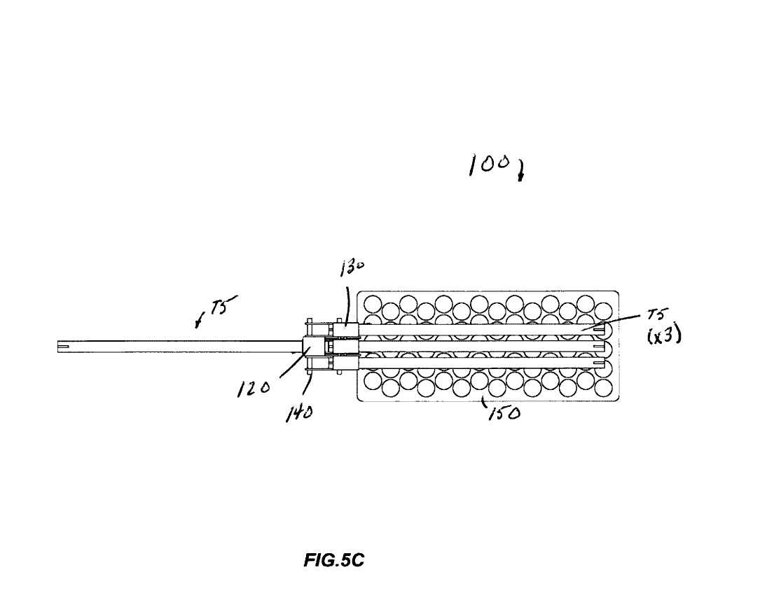

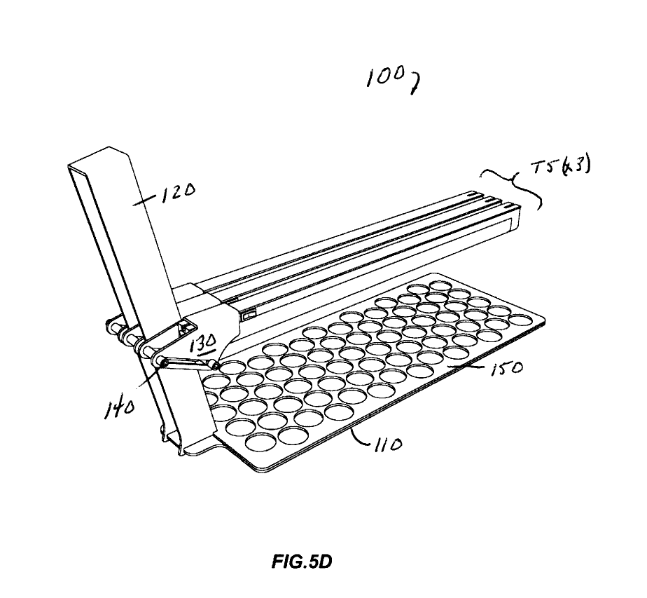

Depicted in FIG. 5A is a front perspective view of an alternative embodiment of modular lighting structure 100 of FIG. 1, configured to support three elongated lamp or bulb assemblies T5 in a “side-by-side” configuration in a forward orientation. In such embodiment, second and third saddle assemblies 130 are received by vertical support 120. First, second, and third saddle assemblies 130 may be joined in tandem arrangement by suitably configured tension assemblies 140 spanning from an outer side of first saddle assembly 130, through second and third saddle assemblies 130, and terminating in an outer side of third saddle assembly 130. It will be further appreciated that additional saddle assemblies 130 may be added in similar tandem arrangement and joined by suitably configured tension assemblies 140 spanning thereacross as previously described, for supporting one each elongated lamp or bulb assembly T5.

FIG. 5B depicts a perspective view of an alternative embodiment of modular lighting structure 100 of FIG. 5A supporting three elongated lamp or bulb assemblies T5 in a “side-by-side” configuration in a forward orientation and one elongated lamp or bulb assembly T5 in a rearward orientation. In this view, the tandem arrangement of saddle assemblies 130 and tension assemblies 140 better may be seen. It will be further appreciated that additional saddle assemblies 130 may be added in similar tandem arrangement, whether in forward or rearward facing arrangement, or both, and joined by suitably configured tension assemblies 140 spanning thereacross as previously described, for supporting one each elongated lamp or bulb assembly T5.

As well, although FIG. 5B depicts rearward facing elongated lamp or bulb assembly T5 at an elevation lower than forward facing elongated lamp or bulb assemblies T5, it will be readily apparent that the relative elevation positions may be reversed, so that forward facing elongated lamp or bulb assemblies T5 are at an elevation lower than rearward facing elongated lamp or bulb assembly T5. As well, it will be appreciated that the number of forward and rearward facing elongated lamp or bulb assemblies T5 may be reversed or otherwise altered, so long as there is sufficient counterweight, clamping force, or base weight available to prevent unwanted tipping of modular lighting structure 100.

FIG. 5C depicts a top view of modular lighting structure 100 of FIG. 5B supporting three elongated lamp or bulb assemblies T5 in a “side-by-side” configuration in a forward orientation and a one elongated lamp or bulb assembly T5 in a rearward orientation.

FIG. 5D depicts a rear perspective view of modular lighting structure 100 of FIG. 5A supporting three elongated lamp or bulb assemblies T5 in a “side-by-side” configuration in a forward orientation, elongated lamp or bulb assemblies T5 shown adjusted in a relatively lower elevation position along vertical support 120.

Turning next to FIGS. 6-6M, these Figures depict and demonstrate a series of exemplary steps and corresponding exemplary methods of construction of an embodiment of modular lighting structure 100 of FIG. 1. During review of these Figures, it will become apparent that, advantageously, each component part may be provided in a flat form, conducive to easy packing within a relatively flat package, whereby storage, handling, shipping, and subsequent re-storage may be economized.

FIG. 6 depicts a top view of a representative modular lighting structure 100 of the present disclosure in parts. In this view may be seen base 110, vertical support 120, saddle assembly 130, tension assemblies 140 in exploded view, and elongated lamp or bulb assembly T5. In this view may also better be seen cooperating slots 160 described above with regard to FIG. 3.

FIG. 6A depicts a top isometric view of a representative modular lighting structure 100 of FIG. 6 in parts. Also in this view may be seen base 110, vertical support 120, saddle assembly 130, tension assemblies 140 in exploded view, and elongated lamp or bulb assembly T5.

FIG. 6B depicts a side isometric view of modular lighting structure 100 of FIG. 6A in parts. In this view, vertical support 120 is bent or otherwise formed into an inverted U-shape.

FIG. 6C depicts a side isometric view of modular lighting structure 100 of FIG. 6B in parts. In this view, vertical support 120, as formed into shape as described in FIG. 6A, is pressed or slid into corresponding slots 160 on base 110.

FIG. 6D depicts a side isometric view of modular lighting structure 100 of FIG. 6C in parts. In this view, saddle assembly plate 130 is bent or otherwise formed into the configuration shown in FIGS. 1-5D.

FIG. 6E depicts a side isometric view of modular lighting structure 100 of FIG. 6D in parts. In this view, saddle assembly plate 130, formed as described with regard to FIG. 6D, is slid or disposed onto a T5 lighting lamp.

FIG. 6F depicts a side isometric view of modular lighting structure 100 of FIG. 6E in parts. In this view, one of the plurality of tensioning assemblies 140 is shown next to saddle plate 130, and readied for installation. In this view and embodiment, each tension assembly 140 is seen to comprise threaded members 180 associated with offset spacer 190 at each of a first and second end thereof. It will be apparent that any of a variety of equivalent structures may be provided to serve an equivalent function.

For example, threaded members 180 may comprise any of a variety of forms of screw fastener, any of a variety of forms of cooperating threaded receiving elements, threaded rods, thumb screws, threaded caps, and elements of like function and purpose, and combinations thereof. Each offset spacer 190 may be threaded at each end, or completely therethrough, so as to receive threaded members 180; or, it may have a smooth bore or hole therethrough, whereby a fully or partially threaded member 180 may pass therethrough for external fastening. In any form, the purpose to be fulfilled is capturing and holding the sides of saddle plate 130 in appropriate tension/compression arrangement in association with vertical support 120 by operation of offset spacers 190 in association with threaded members 180. In appropriate configurations, one or more guiding offset rests may be positioned in association with threaded members 180, offset spacers 190, and saddle plate 130 so as to ensure that appropriate alignment of these respective elements is maintained, and that sufficient tensile/compressive force is established and maintained for the aforedescribed purpose.

FIG. 6G depicts a side isometric view of modular lighting structure 100 of FIG. 6F in parts. In this view, tension assembly 140 is depicted within and spanning saddle plate 130, as was described above.

FIG. 6H depicts a side isometric view of modular lighting structure 100 of FIG. 6G in parts. In this view, elongated lamp or bulb assembly T5 and saddle plate 130 with one tension assembly 140 is positioned in front of vertical support 120.

FIG. 6i depicts a side isometric view of modular lighting structure 100 of FIG. 6H in parts. In this view, elongated lamp or bulb assembly T5 and saddle plate 130 with one tension assembly 140 is pushed into vertical support 120. Thereafter, a second tension assembly 140 is positioned and installed at a rear of saddle plate 130.

FIG. 6J depicts a side isometric view of modular lighting structure 100 of FIG. 6I in fully constructed form. It is seen that elongated lamp or bulb assembly T5 may be retained and supported at any of a variety of user-selected elevations along vertical support 120.

FIG. 6K depicts a side isometric view of modular lighting structure 100 of FIG. 6J. In this view, saddle assembly 130 is tilted in the direction of arrow T to release the leveraged tension from terminating ends of tension assemblies 140. Once this tension is released and saddle assembly 130 is tilted, elongated lamp or bulb assembly T5 can easily be moved, as described with consideration of FIG. 6L, upwardly or downwardly along vertical support 120 and into any of a plurality of user-selected positions along vertical support 120.

Accordingly, FIG. 6L depicts a side isometric view of modular lighting structure 100 of FIG. 6K. In this view, saddle assembly 130 is tilted in the direction of arrow T to release the leveraged tension from terminating ends of tension assemblies 140. Saddle assembly 130 is tilted and moved upwardly in the direction of arrow U along vertical support 120 and into any of a plurality of user-selected positions along vertical support 120.

FIG. 6M depicts a side isometric of modular lighting structure 100 of FIG. 6L. In this view, saddle assembly 130 has been released from the tilted position in the direction of arrow T, wherein tension has been placed onto terminating ends of tension assemblies 140 to fix saddle assembly 130 into a higher portion of vertical assembly 130. In this manner, elongated lamp or bulb assembly T5 is supported at a higher elevation than that shown in FIG. 6J.

FIGS. 7-7F depict and demonstrate a series of exemplary steps and a corresponding exemplary method of construction of an alternative embodiment of modular lighting structure 100 of FIG. 1. During review of these Figures, it will become apparent that, advantageously, each component part may be provided in a flat or low profile form, conducive to easy packing within a relatively flat package, whereby storage, handling, shipping, and subsequent re-storage may be economized. As well, it will become apparent that, in this form, a user may easily and conveniently assemble a modular lighting structure fulfilling each of the previously described attributes, and do so without the need for, or use of, tools.

FIG. 7 depicts a top view of an alternate embodiment of saddle assembly 130 parts matrix 200 before the respective parts are separated from tabs 210 retaining the parts within cut out negative 220. It is noted that the process of separating respective parts from matrix 200 preferably is easily done by hand of the end-user, and that tools preferably would not be required. As will be described in greater detail hereinbelow, FIG. 7 depicts the various parts comprising an alternate embodiment of saddle assembly 130, including left and right saddle side plates 230, and clips 240, 250, 260, 270, the assembly and functions of which will be described in greater detail hereinbelow.

FIG. 7A depicts a top isometric view of saddle assembly 130 parts matrix 200 of FIG. 7 before the respective parts are separated from the tabs 210 retaining the parts within cut out negative 220.

FIG. 7B depicts a top isometric view of saddle assembly 130 parts depicted by FIG. 7A after the parts are separated from tabs 210. In this view may be seen additional and further features of each part, including respective corresponding slots, tabs, and bearing surfaces, the function and use of which will be described in greater detail hereinbelow.

Accordingly, FIG. 7C depicts a top isometric view of alternate embodiment saddle assembly 130 of FIG. 7B being assembled in stages, progressing through the assembly process from leftmost to rightmost subview. As was described in greater detail above, saddle assembly 130 is used to hold and retain elongated lamp or bulb assembly T5. It may be seen in the progressing FIG. 7C, and beginning with the leftmost subview thereof, that left and right saddle side plates 230 are arranged in desired configuration adjacent elongated lamp or bulb assembly T5. Clips 240, 250, 260, 270 are shown in exploded arrangement and in respective positions adjacent their corresponding slots 232 within left and right saddle side plates 230 and a corresponding T-shaped slot within the rear of elongated lamp or bulb assembly T5.

Progressing within FIG. 7C to the second subview from the left, tab 242 of clip 240 is placed and disposed within corresponding T-shaped slot within the rear of elongated lamp or bulb assembly T5. In the third subview from the left, left and right saddle side plates 230 are brought against elongated lamp or bulb assembly T5, whereafter clips 240, 250 are inserted and locked, via their respective, corresponding slot structures, into corresponding slots 232 within left and right saddle side plates 230. In the fourth subview from the left, clip 260 is inserted and locked, via its respective, corresponding slot structures, into corresponding slots 232 within left and right saddle side plates 230; thereby, completing the assembly process for alternative embodiment saddle assembly 130 and its joinder to elongated lamp or bulb assembly T5. It is noted that, in some embodiments wherein elongated lamp or bulb assembly T5 is provided with a differing form of slotted attachment structure, clip 270 may be substituted for clip 240. It will be observed that, preferably, no tools are required by an end-user in order to follow the steps of this method and to complete the aforedescribed alternative embodiment saddle assembly 130 construction.

Turning next to FIG. 7D, depicted is a top view of an alternative embodiment of base assembly 110 shown with alternative embodiment vertical support cross members 122. As may be seen in this Figure, left and right vertical support cross members 122 for alternative embodiment vertical support assembly 120 are fabricated within base 110. Vertical support cross members 122 may be separated from tabs 124 and, thereafter, be assembled by hand of the end user into vertical support assembly 120, as will be described in greater detail hereinbelow.

Left and right vertical support cross members 122 each have holes 126 disposed therein, which are configured to receive tension assemblies 140, as will be further described below. Left and right vertical support cross members 122 each have toothed edge 128, which is configured to receive and support appropriate ones of corresponding tabs and bearing surfaces associated with clips 250, 260, as also will be described in greater detail hereinbelow.

As well, each of left and right vertical support cross members 122 has a slot 160. Slots 160 are configured to be inserted, following construction of vertical support assembly 120 according to a process such as described in greater detail below, into corresponding slots 160 within tongue 112 of base 110.

FIG. 7E depicts a top isometric view of alternative embodiment base 110 of FIG. 7D. Base 110 is shown without vertical support cross members 122 within the base, as in configuration following separation of vertical support cross members 122 therefrom. It may be observed that, in some embodiments, base 110 may comprise a low profile, pre-bent form. Such alternative form may be conducive in providing clearance for vertical support 120, as well as providing space under base 110 for any other use which a user may determine. Such uses may include placement of a drip tray, a repository for spilled dirt, a non-slip surface mat, or the like, as may be occasioned or desirable due to presence of openings 114 following separation of vertical support cross members 122 from base 110.

Turning next to FIG. 7F, depicted is an exploded, isometric view of the alternative embodiment of vertical support assembly 120 of FIG. 7D. In this view, tension assemblies 140 are shown in configuration for fastening upper and lower ends of vertical support cross members 122 into a rigid structure for vertical support 120. In this Figure, it may be seen that threaded members 180 are passed through respective holes 126 in vertical support cross members 122, and into offset spacer 190, capturing offset spacer 190 between vertical support cross members 122. As described above, following construction of vertical support assembly 120, it may be assembled with base 110 via cooperating, corresponding slots 160 formed within each.

Next, FIG. 8 depicts an isometric view of an alternative embodiment of modular lighting structure 100 of the present disclosure. In this configuration, layered, modular clamping mechanism 300 is provided in lieu of base 110. In this embodiment, clamping mechanism 300 is constructed via a process and steps similar to those described hereinabove with reference to some embodiments of saddle assembly 130 and vertical support 120, resulting in a similar, layered, “sandwich” form of construction. Specifically, it may be seen in FIG. 8 that left and right sides 322 of clamping mechanism 300 are separated via tension assemblies 140. Like other structures joined by tension assemblies 140, such as have been described hereinabove, tension assemblies 140 provide structural rigidity and stability to the resulting construct of clamping mechanism 300.

From FIG. 8, it will be appreciated that threaded members 180 are passed through respective holes in left and right sides 322 of clamping mechanism 300, and into respective ones of offset spacers 190, capturing offset spacers 190 between left and right sides 322 of clamping mechanism 300. It will be appreciated that alternative embodiments of offset spacers 190 may be provided, and even intermixed as shown in the Figure, in order to serve a particular purpose within the provided form.

For example, in FIG. 8, two alternative forms of offset spacers 190 are depicted. In cylindrical form, offset spacers 190 best function to separate left and right sides 322 of clamping mechanism 300 in a space-efficient configuration. In the form of rectangular prism or cuboid shapes, offset spacers 190 best function to provide effective and efficient means and surfaces for clamping modular lighting structure 100 to surface S, where surface S may take such forms as a table top, counter top, shelf, or the like. Appropriate forms of offset spacers 190 may also be provided to receive bearing forces and transmit clamping forces from clamping knob 340 into clamping mechanism 300.

In view of the discussion set forth above with regard to FIGS. 7-7F, it will be appreciated that clamping mechanism 300 advantageously could be provided in a flat, matrix-of-parts form, for separation and assembly by hand of an end user. Similar to the discussion surrounding those Figures, such a matrix-based form for the component parts of clamping mechanism 300 would provide each of the benefits set forth in the prior, associated descriptions, including, for example, being conducive to easy packing within a relatively flat package, whereby storage, handling, shipping, and subsequent re-storage may be economized; and being easily and conveniently assembled without the need for, or use of, tools.

Attention is here drawn to certain additional functionality that may be seen with reference to FIG. 8. Specifically, as was described hereinabove with regard to FIGS. 1 and 6J-6M, it will be seen that the construction of saddle assembly 130 as set forth in FIGS. 7-7C conductively provides for upward tilting of saddle assembly 130 and its corresponding elongated lamp or bulb assembly T5, removing the associated bearing forces from clips 250, 260 within toothed surfaces 128 and the bearing surfaces forward of vertical support 120, and allowing saddle assembly 130 and its elongated lamp or bulb assembly T5 to be moved upwardly or downwardly along vertical support 120 and into any of a variety of user-selected positions along toothed surface 128 and the bearing surfaces forward of vertical support 120. When saddle assembly 130 and its elongated lamp or bulb assembly T5 is in an appropriate position, saddle assembly 130 and its elongated lamp or bulb assembly T5 is tilt-lowered back into its resting, re-tensioned position, wherein it is maintained by normal bearing forces until moved again by the user.

Continuing with reference to the Figures, FIG. 8A depicts a side isometric view of the modular lighting structure of FIG. 8 clamped to a work surface S. From this view, one may also further observe the function, arrangement, and use of saddle assembly 130 and clips 250, 260 in association with toothed surfaces 128 and the bearing surfaces forward of vertical support 120. As well, one may also further observe the function, arrangement, and use of rectangular prism or cuboid-shaped, offset spacers 190 in providing effective and efficient means and surfaces for clamping modular lighting structure 100 to surface S.

Finally, FIG. 8B depicts a rear isometric view of modular lighting structure 100 of FIG. 8 clamped to work surface S. In this view, one may further observe function, arrangement, and use of saddle assembly 130 and clips 250, 260 in association with toothed surfaces 128 and the bearing surfaces forward of vertical support 120. As well, one may also further observe the function, arrangement, and use of clamping knob 340 in association with rectangular prism or cuboid-shaped, offset spacers 190 in providing effective and efficient means and surfaces for clamping modular lighting structure 100 to surface S.

Having thus described exemplary embodiments of the subject matter of the present disclosure, it is noted that the within disclosures are exemplary only and that various other alternatives, adaptations, and modifications may be made within the scope and spirit of the present invention. Accordingly, the present subject matter is not limited to the specific embodiments as illustrated herein, but is limited only by the following claims.

What is claimed:

1. A modular lighting structure comprising:
a vertical support, said vertical support comprising a left side and a right side, said left side and right side interconnected therebetween;
a saddle assembly, said saddle assembly configured to hold a lamp or bulb for lighting a surface; and
means for removably affixing said vertical support to a base, to a surface, or to both.

2. The modular lighting structure of claim 1 wherein said interconnection between said left side and said right side comprises a medial section disposed between said left side and said right side.

3. The modular lighting structure of claim 2 wherein said vertical support forms an inverted U-shape.

4. The modular lighting structure of claim 1 wherein said interconnection between said left side and said right side comprises a tension assembly.

5. The modular lighting structure of claim 4 wherein said tension assembly comprises an offset spacer and a cooperating tensioning member.

6. The modular lighting structure of claim 1 wherein said vertical support comprises a non-perpendicular angle with respect to the base, to the surface, or to both.

7. The modular lighting structure of claim 1 wherein an edge surface of said left side, said right side, or both comprise a toothed surface configured to cooperate with said saddle assembly and, thereby, to reduce slipping of said saddle assembly along said vertical support.

8. The modular lighting structure of claim 1 wherein said saddle assembly comprises a left saddle plate and a right saddle plate, said left saddle plate and said right saddle plate interconnected by one or more clip.

9. The modular lighting structure of claim 1 wherein said saddle assembly is configured to tilt with respect to said vertical support; and, thereby, to move upwardly, downwardly, or both along said vertical support.

10. The modular lighting structure of claim 9 wherein said saddle assembly is configured to maintain a stationary rest position when not tilted with respect to said vertical support.

11. The modular lighting structure of claim 1 wherein said saddle assembly is configured to hold the lamp or bulb in a cantilevered-type support arrangement.

12. The modular lighting structure of claim 1 wherein said means for removably affixing said vertical support to a base, to a surface, or to both comprises a notch formed within one or each of said vertical support, base, or surface.

13. The modular lighting structure of claim 1 wherein said means for removably affixing said vertical support to a base, to a surface, or to both comprises a clamp.

14. The modular lighting structure of claim 1 wherein said vertical support components, said saddle assembly components, or both are configured in essentially flat form, and are configured to be removed from such flat form and subsequently assembled into said modular lighting structure.

15. The modular lighting structure of claim 1 further comprising a seed tray.

16. A modular lighting structure comprising:
an inclined vertical support;
a saddle assembly configured to hold a lamp or bulb for lighting a surface;
said saddle assembly further comprising a first tension assembly, said first tension assembly located forward of said saddle assembly with respect to said vertical support, and a second tension assembly, said second tension assembly located rearward of said saddle assembly with respect to said vertical support;
whereby, when said saddle assembly is tilted upwardly, said saddle assembly is allowed to move upwardly, downwardly, or both along said vertical support and into any of a variety of user-selected positions; and
whereby, when said saddle assembly is tilted downwardly into a resting position, it is maintained in that resting position.

17. The modular lighting structure of claim 16 wherein an edge surface of said vertical support comprises a toothed surface configured to cooperate with said saddle assembly and, thereby, to reduce slipping of said saddle assembly along said vertical support.

18. The modular lighting structure of claim 16 wherein said saddle assembly comprises a left saddle plate and a right saddle plate, said left saddle plate and said right saddle plate interconnected by one or more clip.

19. A modular lighting structure comprising:
an inclined vertical support;
a plurality of saddle assemblies, each one of said plurality of saddle assemblies configured to hold a respective lamp or bulb for lighting a surface;
said plurality of saddle assemblies further comprising a first tension assembly, said first tension assembly located forward of each of said plurality of saddle assemblies with respect to said vertical support, and a second tension assembly, said second tension assembly located rearward of each of said saddle assemblies with respect to said vertical support;
whereby, when said saddle assemblies are tilted upwardly, said saddle assemblies are allowed to move upwardly, downwardly, or both along said vertical support and into any of a variety of user-selected positions; and
whereby, when said saddle assemblies are tilted downwardly into a resting position, said saddle assemblies are maintained in that resting position.

20. The modular lighting structure of claim 16 wherein each said saddle assembly comprises a left saddle plate and a right saddle plate, said left saddle plate and said right saddle plate interconnected by one or more clip.
